(19) United States
(12) Patent Application Publication
(10) Pub. No.: US 2008/0300043 A1
(43) Pub. Date: Dec. 4, 2008

(54) SLOT MACHINE FOR ACCEPTING A BET OF A GAMING VALUE ON ONE-BY-ONE REEL DISPLAY PART BASIS AND VARIABLY DISPLAYING SYMBOLS AT BETTED REEL DISPLAY PARTS

(75) Inventor: Hiro SAKUMA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corporation, Koto-ku (JP)

(21) Appl. No.: 12/025,295

(22) Filed: Feb. 4, 2008

(30) Foreign Application Priority Data
Feb. 13, 2007 (JP) 2007-032408

(51) Int. Cl. A63F 9/24; A63F 13/00

(52) U.S. Cl. 463/20

(57) ABSTRACT

A slot machine is provided with first to third reel display areas 10 to 12 at a lower image display panel 6. In a start accepting process (S11), a main CPU41 accepts a bet of a gaming value on a one-by-one reel display area basis. At this time, the number of bets relative to each reel display area is limited to be equal to or smaller than a predetermined bet limit (S27). The main CPU41 performs a symbol determining process (S12) and a symbol display process (S13) for only a target reel display area in which a gaming value is betted. After that, the main CPU41 determines the content of a first prize, based upon a symbol displayed in a stopped state in the target reel display area. The main CPU41 determines the content of a second prize in addition to that of the first prize if it is predetermined.

### BACKGROUND OF THE INVENTION

1. Field of the Invention

The present invention relates to a slot machine provided with real display parts at which plural types of symbols are variably displayed and displayed in a stopped state, and in particular, to a slot machine of accepting a bet on a one-by-one reel display part basis and variably displaying symbols at the betted reel display parts.

2. Description of the Related Art

In a slot machine, reels of which plural types of symbols are displayed on an outer circumferential face are arranged in a multiply-rotatable manner. Then, after a predetermined gaming value (such as credits, for example) is betted, when a predetermined operation (operation of a start button or a start lever, for example) is performed, symbols are variably displayed by rotation of the reels. A bet of a gaming value generally aims at a payline specified over a plurality of reels or all symbols displayed in a stopped state at the plurality of reels. After variable display of symbols is started, when a predetermined time has elapsed, the symbols of the reels are displayed in a stopped state, respectively, based upon a result of internal lottery. Then, a combination of the symbols displayed in a stopped state and a payment based upon the content of a bet is given to a player.

Apart from the mechanical slot machine as described above, a video slot machine using a video reel in which a reel is expressed in a simulative manner is also known. In this video slot machine, a video reel is expressed by variably displaying symbol columns constituted of plural types of symbols on a display. In this regard, in the video slot machines also, like mechanical slot machines, symbols are variably displayed by all video reels. One of such slot machines, for example, a slot machine disclosed in U.S. Pat. No. 7,037,191 is known.

In the slot machine disclosed in U.S. Pat. No. 7,037,191, as described above, after a bet operation relative to a payout line is made, all of five reels are rotationally driven using a gaming value (such as credits, for example). Then, the slot machine is constituted so that symbols are displayed in a stopped state, based upon a result of internal lottery, and then, a payout is awarded, based upon a combination of symbols displayed to be stopped in a winning line.

Namely, in the slot machine, gaming values are betted on all reels, thus making it necessary to rotationally drive all reels. Namely, in the slot machine disclosed in U.S. Pat. No. 7,037,191, a control process pertinent to variable display of symbols is required for all of the five reels.

The present invention relates to a slot machine provided with reel display parts at which plural types of symbols are variably displayed and are displayed in a stopped state, and in particular, provides a slot machine, which is capable of reducing a processing burden on control associated with the reel display parts.

### SUMMARY OF THE INVENTION

According to a first aspect of the present invention, a slot machine is provided with: a display device configured to have a plurality of reel display parts at which plural types of symbols are variably displayed and are displayed in a stopped state; and a game controller configured to: a) arbitrarily accept a bet of a gaming value on a one-by-one reel display part basis with respect to each of a plurality of reel display parts formed on the display device; b) determine a symbol displayed in a stopped state at a reel display part at which the gaming value is betted; c) variably display the symbol at the reel display part at which the gaming value is betted, and then, display the determined symbol in a stopped state at the reel display part; and d) determine the content of a prize, based upon the symbol displayed in a stopped state at the betted reel display part, and then, give an award that is based upon the determined content of the prize.

According to the slot machine of the first aspect, having the constituent elements above, gaming values can be arbitrarily betted, respectively, at a plurality of reel display parts formed at a display. In the slot machine, plural types of symbols are variably displayed at the betted reel display parts. That is, a control process pertinent to variable display of symbols is performed for the reel display parts at which gaming values are betted, thus making it possible to reduce a processing burden on variable display of symbols according to a game controller. The slot machine can arbitrarily bet a gaming value on a one-by-one reel display part basis, thus making it possible to differentiate the gaming values betted on the reel display parts. As a result, the aspects of bets of gaming values are diversified, so that the slot machine can give a player a new entertainment.

According to a slot machine of the second aspect, the slot machine of claim 1 is provided, wherein the game controller is configured to set a maximum limit of a gaming value that can be betted with respect to the reel display part, and accept a bet of a gaming value relative to the reel display part in the range up to the set maximum limit. In addition, a maximum limit according to one reel display part is different from a maximum limit according to another reel display part.

According to the slot machine of the second aspect, having the constituent elements above, a gaming value can be arbitrarily betted on a one-by-one reel display part basis in the range up to a maximum limit set at each of the reel display parts. A maximum limit according to one reel display part is different from that according to another reel display part, so that, even if gaming values are betted at all of the reel display parts to the maximum bet limit, an amount of the bet gaming value is different depending upon each of the reel display parts. Namely, conditions pertinent to the contents of prizes are different from each other on a one-by-one reel display part basis, so that the slot machine can give a player an entertainment that is based upon the fact that betting is arbitrarily possible on a one-by-one reel display part basis.

According to a third aspect of the present invention, a slot machine is provided with: a display device having a plurality of reel display parts at which plural types of symbols are variably displayed and are displayed in a stopped state; and a game controller configured to: a) arbitrarily accept a bet of a game value on a one-by-one reel display part basis with respect to each of plural reel display parts formed on the display device; b) determine a symbol displayed in a stopped state at a reel display part at which the gaming value is betted; c) variably display the symbol at the reel display part at which the gaming value is betted while maintaining a stopped state of a symbol at a reel display part at which the gaming value is not betted, and then, display the determined symbol in a stopped state at the reel display part at which the gaming value is betted; and d) determine the content of a prize based upon the symbol displayed in a stopped state at the bet reel display part, and then, give an award that is based upon the determined content of the prize.

According to the slot machine of the third aspect, having the constituent elements above, gaming values can be arbitrarily betted, respectively, on a plurality of reel display parts formed at a display. In the slot machine, plural types of symbols are variably displayed at the bet reel display parts. Symbols are maintained to be displayed in a stopped state at other reel display parts that are not betted. That is, symbols are variably displayed only at reel display parts requiring variable display of symbols, so that a control process pertinent to variable display of symbols can be restrained to its required minimum. As a result, the slot machine can reduce a processing burden by restraining the processing burden pertinent to variable display of symbols to its required minimum. The slot machine can arbitrarily bet a gaming value on a one-by-one reel display part basis so that the gaming values bet on the reel display parts can be differentiated. As a result, the aspects of bets of gaming values are diversified, so that the slot machine can offer a new entertainment to a player.

According to a fourth aspect of the present invention, the game controller in the slot machine of the third aspect is configured to set a maximum limit of a gaming value that can be betted with respect to the reel display part and accept a bet of a gaming value relative to the reel display part in a range up to the set maximum limit, and a maximum limit according to one reel display part is different from a maximum limit according to another reel display part.

According to the slot machine of the fourth aspect, having the constituent elements above, a gaming value can be arbitrarily betted on a one-by-one reel display part basis in the range up to the maximum limits set at the reel display parts. A maximum limit according to one reel display part is different from that according to other reel display part, so that, even if gaming values are betted at all of the reel display parts up to the maximum limits, the amounts of the betted gaming values are different depending upon each of the reel display parts. Namely, conditions pertinent to the contents of prizes are different from each other on a one-by-one reel display part basis, so that the slot machine can offer to a player an entertainment that is based upon the fact that arbitrary betting is possible on a one-by-one reel display part basis.

According to a fifth aspect of the present invention, a slot machine is provided with: a display device having a plurality of reel display parts at which plural types of symbols are variably displayed and are displayed in a stopped state; and a game controller configured to: a) arbitrarily accept a bet of a gaming value on a one-by-one reel display part basis with respect to a plurality of reel display parts formed on the display; b) determine a symbol displayed in a stopped state at a reel display part at which the gaming value is betted; c) variably display the symbol at the reel display part at which the gaming value is betted and maintain a stopped state of a symbol at a reel display part at which the gaming value is not bet, and then, display the determined symbol in a stopped state at the reel display part at which the gaming value is betted; and d) determine the content of a first prize that is based upon a symbol displayed in a stopped state at the bet reel display part, based upon the content of the prize specified for the symbol, and determine the content of a second prize that is based upon a combination of symbols consisting of symbols displayed in a stopped state at a plurality of bet reel display parts, and then, give awards based upon the contents of the first and second prizes.

According to the slot machine of the fifth aspect, having the constituent elements above, gaming values can be arbitrarily betted, respectively, on a plurality of reel display parts formed at a display. In the slot machine, plural types of symbols are variably displayed at the betted reel display parts, and symbols are maintained to be displayed in a stopped state at other reel display parts that are not betted. That is, symbols are variably displayed at only the reel display parts requiring variable display of symbols, so that a control process pertinent to variable display of symbols can be restrained to its required minimum. As a result, the slot machine can reduce a processing burden by restraining a processing burden on variable display of symbols to its required minimum. The slot machine can arbitrarily bet a gaming value on a one-by-one reel display part basis, thus making it possible to differentiate the gaming values betted on the reel display parts. As a result, the aspects of bets of gaming values are diversified, so that the slot machine can offer a new entertainment to a player. Further, the slot machine is constituted so as to give an award, based upon the content of the first prize that is based upon symbols displayed in a stopped state at the bet reel display parts and the content of the second prize that is based upon a combination of symbols consisting of those displayed in a stopped state at a plurality of betted reel display parts. As a result, the slot machine can give a player an expectation pertinent to a large profit that is based upon the contents of the first and second prizes.

A slot machine of the sixth aspect of the present invention is provided, wherein the game controller of the slot machine of the first embodiment is configured to set a maximum limit of a gaming value that can be betted on the reel display part and accept a bet of a gaming value on the reel display part to the set maximum limit. A maximum limit according to one reel display part is different from that according to another reel display part.

According to the slot machine of the sixth aspect, having the constituent elements above, a gaming value can be arbitrarily betted on a one-by-one reel display part basis in the range up to the maximum limit set at each of the reel display parts. A maximum limit according to one reel display part is different from that according to another reel display part, so that, even if gaming values are betted at all of the reel display parts up to the maximum limit, the amounts of betted gaming values are different depending upon the reel display parts. Namely, conditions pertinent to the contents of prizes are different on a one-by-one reel display part basis, so that the slot machine can offer to a player an entertainment that is based upon the fact that betting is arbitrarily possible on a one-by-one reel display part basis.

According to the slot machine of the present invention, gaming values can be arbitrarily betted, respectively, at a plurality of reel display parts formed at a display. The gaming values betted on the reel display parts can be thereby differentiated. As a result, the aspects of bets of gaming values are diversified, so that the slot machine can offer a new entertainment to a player. In the slot machine, plural types of symbols are variably displayed at the betted reel display part. That is, a control process pertinent to variable display of symbols is performed for reel display portions at which gaming values are bet, so that a processing burden on variable display of symbols can be reduced in comparison with a case in which symbols are variably displayed at all of the reel display parts.

### BRIEF DESCRIPTION OF THE DRAWINGS

FIG. 1 is a view illustrating one display aspect of a lower image display panel while a game is executed;

FIG. 2 is an external perspective view of a slot machine;

FIG. 3 is a block diagram showing a control system of the slot machine;

FIG. 4 is a flow chart of a main control processing program;

FIG. 5 is a flow chart of a main game processing program;

FIG. 6 is a flow chart of a start accepting processing program;

FIG. 7 is an illustrative view schematically depicting a setting pattern table;

FIG. 8 is a flow chart of a symbol determination processing program;

FIG. 9 is a flow chart of a symbol determination processing program;

FIG. 10 is a flow chart of an event determination processing program;

FIG. 11 is an illustrative view schematically depicting a table of determining contents of a first prize;

FIG. 12 is an illustrative view schematically depicting a table of determining contents of a second prize;

FIG. 13 is an illustrative view (1) of a lower image display panel on which a symbol is displayed in a stopped state; and

FIG. 14 is an illustrative view (2) of a lower image display panel on which a symbol is displayed in a stopped state.

### DESCRIPTION OF THE PREFERRED EMBODIMENTS

Hereinafter, a gaming machine according to the present invention will be described in detail with referring to the drawings, based upon embodiments of a slot machine. The slot machine according to the embodiment is a so-called video slot machine having an image display device such as a liquid crystal display, wherein a game is performed by variably displaying and displaying in a stopped state, images of various symbols on the image display device.

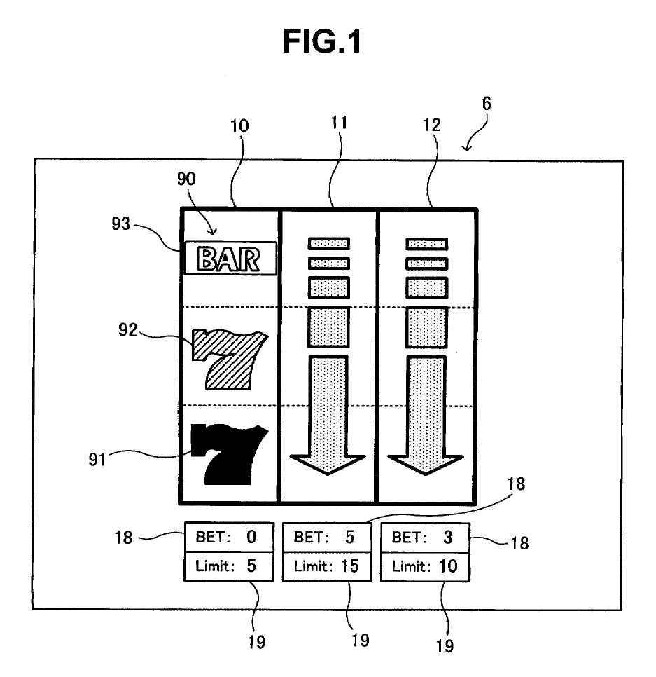

First, an outline of a game performed by a slot machine 1 according to the embodiment will be described in detail with referring to the drawings. In the slot machine 1 according to the embodiment, with respect to first to third reel display areas 10 to 12 formed on a lower image display panel 6, gaming values can be betted in respectively arbitrary number of bets on a one-by-one reel display area basis (see FIG. 1). At this time, in each of the reel display areas, a “bet limit” is determined to be a maximum value of a gaming value that can be betted in each of the reel display areas. Therefore, a player bets a gaming value in the range up to the limit (see FIG. 1). Then, when a game is started based upon the player operation, symbols (i.e., blue seven 91 to blank 100) are variably displayed in the betted reel display areas, and symbols are still left to be displayed in a stopped state in a reel display area that is not betted (see FIG. 1). Accordingly, the slot machine 1 can reduce a processing burden on variable display of symbols in the reel display area.

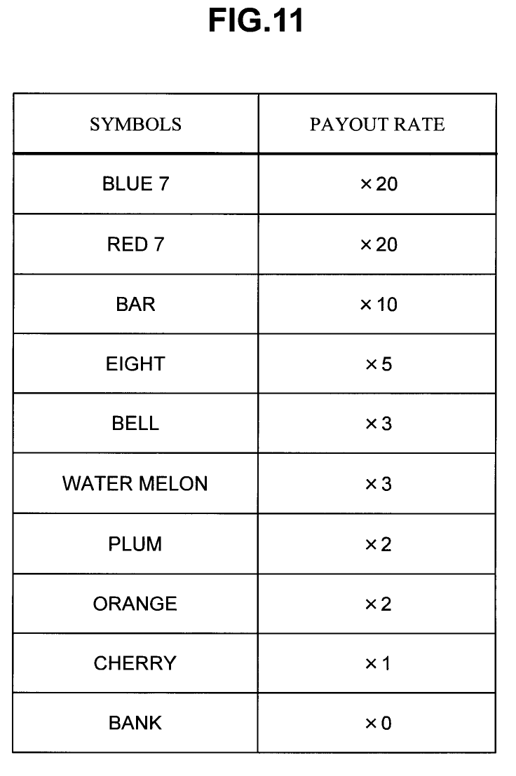

When a predetermined period has elapsed after variable display of symbols, three symbols determined by lottery are displayed in a stopped state in the bet reel display areas. At this time, the slot machine 1 gives an award to a player, based upon the symbols displayed in a stopped state in the betted reel display areas. The award to be given to the player is determined depending upon two types of the contents of first and second prizes. The content of the first prize is determined based upon the payout rate determined for symbols (see FIG. 11) and the number of bets relative to the reel display area. Therefore, a value determined by obtaining a product of the payout rate and the number of bets shown in FIG. 11 and adding up the products, are used as the content of the first prize.

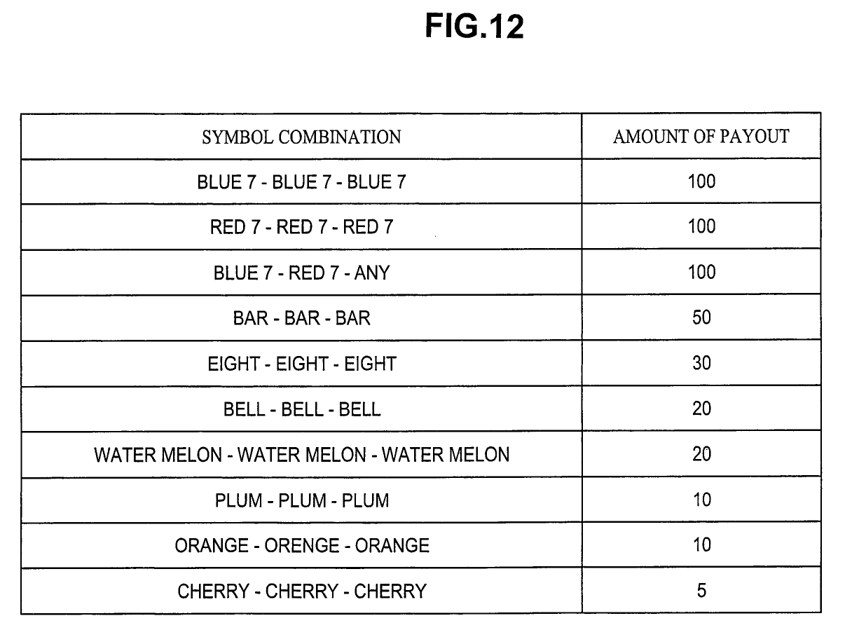

The content of the second prize is given when a plurality of reel display areas are betted. In the embodiment, when all of the first to third reel display areas 10 and 12 are betted, an opportunity of acquiring the content of the second prize is given to the player. In nine symbols displayed in a stopped state in the first to third reel display areas 10 to 12, when a predetermined winning combination (see FIG. 12) is included, the content of the second prize based upon a symbol combination is given to the player.

Because all of the first to third reel display areas 10 to 12 are betted, the award based upon the content of the first prize is given regardless of whether or not a winning combination is included. That is, when a winning combination is included, both of the awards that are based upon the contents of the first and second prizes are given to the player.

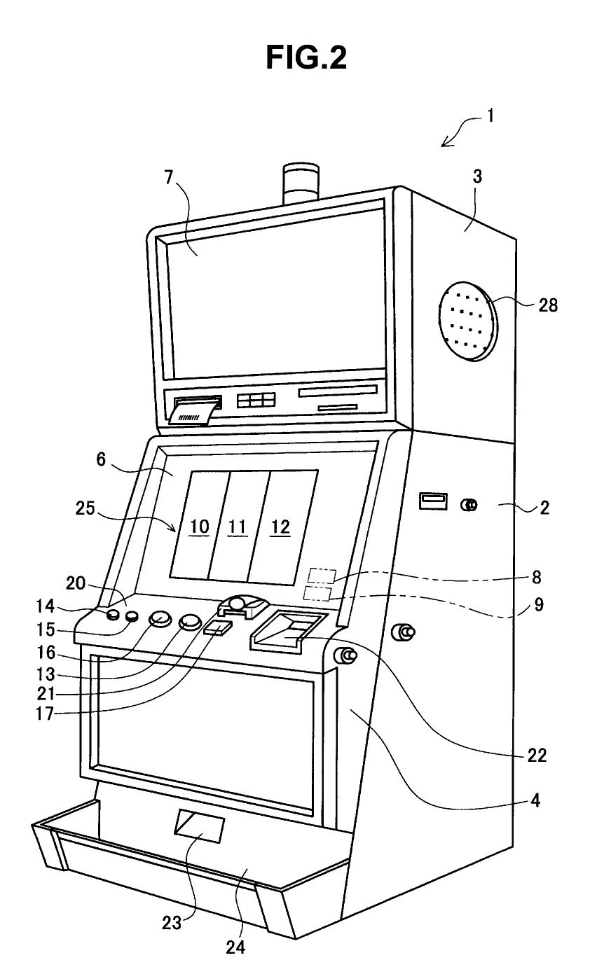

Next, a schematic constitution of the slot machine 1 according to the embodiment will be described in detail with referring to the drawings. FIG. 2 is an external perspective view of a slot machine according to the embodiment. The slot machine 1 according to the embodiment is provided with a cabinet 2, a top box 3, and a main door 4.

The top box is mounted at an upper side of the cabinet 2. An upper image display panel 7 is provided on a front face of this top box 3. A payout table showing the contents of the first and second prizes (see FIGS. 11 and 12), for example, and an explanation of the contents of a game, for example, is displayed on an upper image display panel 7. Further, a speaker 28 for outputting a voice is provided on a side face of the top box 3.

On the other hand, a main door 4 is provided on a front face of the cabinet 2. A lower image display panel 6 is arranged at this main door 4. The lower image display panel 6 is a so-called liquid crystal display. On the lower image display panel 6, a credit number display part 8, a payout number display part 9, first to third reel display areas 10 to 12, a bet number display part 18, and a bet limit display part 19, are formed as shown in FIGS. 1 and 2.

In the slot machine 1 according to the embodiment, three reel display areas, i.e., a first reel display area 10, a second reel display area 11, and a third reel display area 12, are formed from a frontally-viewed left side at the center of the lower image display panel 6. In the reel display areas, symbols are variably displayed and are displayed in a stopped state by a video reel (see FIG. 1). The video reel according to the slot machine 1 is constituted of ten types of symbols, i.e., BLUE7 (blue seven 91), RED7 (red seven 92), BAR (bar 93), EIGHT (eight 94), BELL (bell 95), WATER MELON (water melon 96), PLUM (plum 97), ORANGE (orange 98), CHERRY (cherry 99), and BLANK (blank 100) (see FIGS. 1, 13, and 14). A generic name of these ten types of symbols is referred to as “symbol 90”. In the video reels, of the first, second, and third reel display areas 10, 11, and 12, the ten types of symbols mentioned above are arranged in respectively different aspects. Then, code Nos. are determined for symbols constituting the video reels. Therefore, in a symbol determining process (S13) and a symbol displaying process (S14), determination of symbols and display control of symbols are made based upon code Nos. determined for the symbols.

Further, a bet number display part 18 and a bet limit display area 19 are formed downwardly of each of the first, second, and third reel display areas 10, 11, and 12. The bet number display part 18 is a part of displaying an amount of a gaming value betted on a reel display area (i.e., bet number), and is associated with a reel display area positioned immediately above the display part. That is, a bet number betted with respect to a reel display area positioned immediately above the display part is displayed at each of the bet number display parts 18. The bet limit display part 19 is formed downwardly of the bet number display part 18. A “bet limit”, which is a maximum value of a gaming value that can be betted on a reel display area positioned immediately above the display part, is displayed at the bet limit display part 19.

A credit number display 8 and a payout number display part 9 are displayed downwardly rightward viewed from the front face of the lower image display panel 6. The credit number, which is currently owned by a player, is displayed at the credit number display part 8. On the other hand, a payout provided in one game (i.e., a payout based upon the contents of the first and second prizes) is displayed as a payout number.

A touch panel 25 is arranged on a front face of the lower image display panel 6. The touch panel 25 is an operation means for executing control according to a portion at which a player is pressed. In the embodiment, the touch panel 25 senses a pressing operation relative to the bet number display part 18 associated with the first to third reel display areas 10 to 12. That is, the touch panel 25 functions as an operation means for selecting a reel display area to be betted, when each of the reel display areas is betted.

A control panel 20, a coin insertion slot 21, and a bill validator 22 are provided downwardly of the lower image display panel 6. A plurality of buttons to which instructions according to a game progress by a player are to be input, are arranged on the control panel 20. Specifically, a SPIN button 13, a CHANGE button 14, a CASHOUT button 15, a 1-BET button 16, and a MAX-BET button 17 are provided on the control panel 20. The SPIN button 13 is an operation means for instructing and inputting start of variable display in each reel display area. The CHANGE button 14 is an operation means used to request an attendant of a gaming facility for coin conversion. The CASHOUT button 15 is an operation means for inputting an instruction for paying out a coin according to the number of credits owned by a player (one credit is equivalent to one coin) from a coin payout opening to a coin tray 24. The 1-BET button 16 is an operation means for supplying an instruction for betting one credit in a reel display area among from the credits owned by the player. The MAX-BET button 17 is an operation means for performing an instruction for betting on a game a maximum number of credits that can be betted in each reel display area among the credits owned by the player. That is, the MAX-BET button 17 is an operation means for performing an instruction for betting on a game a credit corresponding to the bet limit determined in a reel display area.

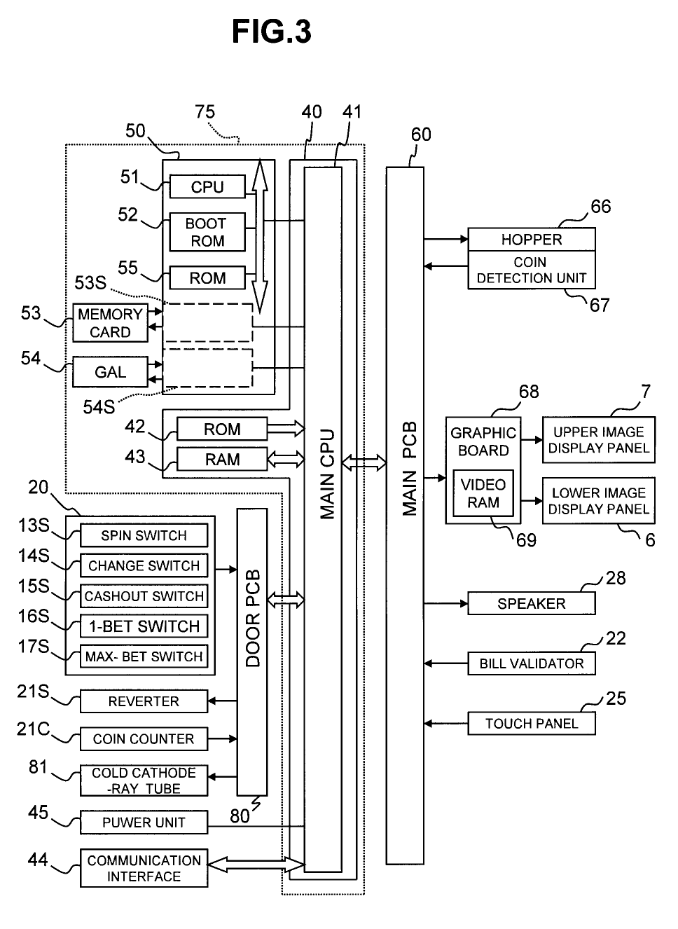

A reverter 21S and a coin counter 21C are provided inside the coin insertion slot 21 (see FIG. 3). The reverter 21A validates whether or not the coin entered into the coin insertion slot 21 is valid. At this time, those other than the valid coins are ejected from the coin payout opening 23. The coin counter 21C detects the coin accepted to be a valid coin, and counts the number of coins. The bill validator 22 validates whether or not a bill is valid and accepts a normal bill in the cabinet 2.

In the slot machine 1 according to the embodiment, coins, bills, or electrical valid information (credits) equivalent thereto are used as gaming media. The gaming media applicable to the present invention can include medals, tokens, and electronic money tickets, for example, without being limitative thereto.

Next, a constitution according to a control system of the slot machine 1 of the embodiment will be described with referring to the drawings. FIG. 3 is a block diagram schematically depicting a control system of the slot machine 1 according to the embodiment. As depicted in FIG. 3, the control system of the slot machine 1 is basically constituted of a mother board 40 and a gaming board 50. That is, a game controller 75 in the slot machine 1 is constituted of a mother board 40 and a gaming board 50.

First, a description of the gaming board 50 will be given. The gaming board 50 is provided with: a CPU51, a ROM55, and a boot ROM52 interconnected by an internal bus; a card slot 53S corresponding to a memory card 53; and an IC socket 54S corresponding to a GAL54 (Generic Array Logic).

The memory card 53 is constituted of a nonvolatile memory, and is a recording medium in which a game program and a game system program (hereinafter, referred to as a game program or the like) are recorded. The game program recorded in the memory card 53 includes a lottery program. This lottery program is principally a program for determining symbols (code Nos. corresponding to symbols) displayed in a stopped state in betted reel display areas. That is, the lottery program is executed when a symbol is determined in symbol determination processing (S13). In addition, the lottery program is also executed in processing other than symbol determination (for example, bet limit determination processing (S21)).

The card slot 53S is constituted so that the memory card 53 can be inserted and removed, and is connected to the mother board 40 by an IDE bus. Therefore, types of the contents of a game performed by the slot machine 1 can be changed by rewriting a game program or the like stored in the memory card 53. The game program includes a variety of data such as programs according to a game progress and image data or sound data to be outputted during gaming.

A GAL54 is one type of PLD having an OR-fixed arrayed structure. The GAL54 is provided with a plurality of input ports and output ports. When predetermined data is input to an input port the GAL54 outputs data corresponding to the predetermined data from the output ports.

An IC socket 54S is constituted so that the GAL54 can be attached and detached. Further, the IC socket 54S is connected to the mother board 40 by a PCI bus. Therefore, output data outputted from the GAL54 can be changed by rewriting of the GAL54 or replacing of the GAL54 per se.

The CPU51, ROM55, and boot ROM52 interconnected by an internal bus are connected to the mother board 40 by the PCI bus. The PCI bus transmits a signal between the mother board 40 and the gaming board 50 and supplies power from the mother board 40 to the gaming board 50. Country identification information and an authentication program are stored in the ROM55. In addition, a program (a boot code) or the like for a preliminary authentication program to boot the preliminary authentication program is stored in the boot ROM52.

The authentication program is a program for authenticating a game program or the like (a falsification check program). This authentication program is described along with procedures for falsification check of a game program targeted for authentication processing. On the other hand, a preliminary authentication program is a program for authenticating the above-described authentication program, and is described along procedures for falsification check of an authentication program targeted for an authenticating process.

Next, a description of the mother board 40 will be given. The mother board 40 is constituted using a commercially available universal motherboard (a printed wiring board having basic parts of a personal computer packaged thereon), and is provided with a main CPU41, a ROM42, a RAM43, and a communication interface 44.

The ROM42 is constituted of a memory device such as a flash memory. In addition, programs such as BIOS executed by the main CPU41 or permanent data contained in a lottery table or the like at the time of execution of a game are stored in the ROM42.

Data or programs used when the main CPU41 boots are stored in the RAM43. The RAM43 can store various programs such as an authentication program and a game program or various items of information such as the number of credits currently owned by a player.

The communication interface 44 is a communication device for making communication with a server or the like mounted in a gaming facility via a communication line. The slot machine 1 can thereby communicate information or the like pertinent to a game at the slot machine 1 with the server or the like via the communication interface 44.

To the mother board 40, a main PCB60 and a door PCB80 described later are connected to each other by a USB. Further, a power unit 45 is connected to the mother board 40. When power is supplied from the power unit 45 to the mother board 40, the main CPU41 of the motherboard 40 is booted. Further, power is supplied to the gaming board 50 via the PCI bus, and the CPU51 is booted.

Devices and units, which generate an input signal relative to the main CPU41, and devices and units of which operation is controlled from the main CPU41 by means of a control signal, are connected to the main PCB60 and the door PCB80. The main CPU41 executes a game program or the like stored in the RAM43, based upon the input signal. With execution of a game program or the like, the main CPU41 performs predetermined computation processing and controlling processing for devices or units.

A hopper 6, a coin detecting section 67, a graphic board 68, a speaker 28, a bill validator 22, and a touch panel 25 are connected to the main PCB60. The hopper 66 is mounted in a cabinet 2, and a predetermined number of coins are paid out from the coin payout opening 23 to the coin tray 24, based upon a control signal from the main CPU41. The coin detecting section 67 is arranged inside the coin payout opening 23, and detects that the predetermined number of coins has been paid out from the coin payout opening 23.

The graphic board 68 controls an image display on the upper and lower image display panels 7 and 6, based upon a control signal from the main CPU41. For example, during game execution, reel display areas are displayed on the lower image display panel 6. Then, based upon an operation signal from the SPIN switch 13S, the graphic board 68 variably displays and displays in a stopped state, symbols constituting a video reel in a bet reel display area. In this case, in a reel display area that is not betted, symbols are not variably displayed, and symbols, which were already displayed in a stopped state by a previous game, are displayed in a stopped state as they are. In addition, the graphic board 68 displays the credit number display part 8, the payout number display part 9, the bet number display part 18, and the bet limit display part 19. Further, the graphic board 68 also performs display control of the upper image display panel 7. Here, the graphic board 68 is provided with: a VDP (Video Display Processor) for generating image data based upon a control signal from the main CPU41; and a video RAM69 or the like for temporarily storing the image data generated by the VDP.

The bill validator 22 validates whether or not a bill is valid and accepts a valid bill in the cabinet 2. When this bill validator accepts the valid bill, the validator outputs a signal based upon an amount of the bill to the main CPU41.

The touch panel 25 functions as an operation means for selecting a reel display area to be betted. As shown in FIG. 3, the touch panel 25 is connected to the main CPU41 via the main PCB60, and thus, an operation signal is output to the main CPU41 when a pressing operation of the bet number display part 18 is sensed. In this manner, the main CPU41 can specify a reel display area to be betted, based upon the operation signal.

On the other hand, a control panel 20, a reverter 21S, a coin counter 21C, and a cold cathode-ray tube 81 are mounted at the rear side of the upper image display panel 7. A SPIN switch 13S, a CHANGE switch 14S, a CASHOUT switch 15S, a 1-BET switch 16S, and a MAX-BET switch 17S are provided on the control panel 20. The SPIN switch 13S is a switch corresponding to the SPIN button 13. The CHANGE switch 14S is a switch corresponding to the CHANGE button 14. The CASHOUT switch 15S is a switch corresponding to the CASHOUT button 15. The 1-BET switch 16S is a switch corresponding to the 1-BET button 16. The MAX-BET switch 17S is a switch corresponding to the MAX-BET button 17. Each of the aforementioned switches outputs an input signal to the main CPU41 when the corresponding button is operated by a player.

The coin counter 21C is arranged inside the coin insertion slot 21. When a player enters a coin into the coin insertion slot 21, the coin counter 21C validates whether or not the entered coin is valid. Those other than valid coins are thereby ejected from the coin payout opening 23, and an input signal is outputted to the main CPU41 when a valid coin is detected.

The reverter 21S distributes the coin that was recognized as a valid coin to a cashbox (not shown) or a hopper 66 in the slot machine 1. The cold cathode-ray tube 81 is mounted at the rear side of each of the lower and upper image display panels 6 and 7. The cold cathode-ray tube 81 functions as a backlight of the lower and upper image display panels 6 and 7.

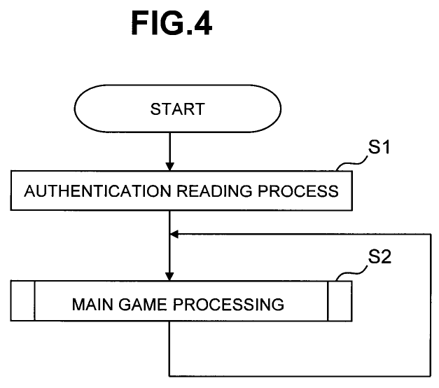

Next, a main control program executed in the slot machine 1 according to the embodiment will be described with referring to the drawings. FIG. 4 is a flow chart of a main control program. In the slot machine 1, a memory card 53 of a gaming board 50 is already inserted into a card slot 53S, and a GAL554 is mounted on an IC socket 54S.

When a power switch is turned ON at a power unit 45 (when power is supplied), a mother board 40 and a gaming board 50 are booted respectively, and then, an authentication reading process (S1) is executed in the slot machine 1. In this authentication reading process, the motherboard 40 and the gaming board 50 execute independent processing operations in parallel, respectively. That is, on the gaming board 50, the CPU51 reads a preliminary authentication program from a boot ROM52, and performs preliminary authentication in accordance with the preliminary authentication program. This preliminary authentication is a process of checking and certifying that falsification of the authentication program is not performed in advance prior to pickup into the mother board 40. On the other hand, on the mother board 40, the main CPU41 executes BIOS, and decompresses in the RAM43 the compression data incorporated in BIOS. Then, this main CPU executes decompressed BIOS, and diagnoses and initializes various peripherals.

After that, the main CPU41 reads an authentication program from the ROM55, and performs authentication of a game program. Game program authentication is a process of checking and certifying that the game program or the like stored in the memory card 53 is not falsified. When this authentication process terminates normally, the main CPU41 writes a game program targeted for authentication into the RAM43, and acquires payout rate setting data and country identification information. After performing the processing described above, the main CPU41 terminates an authentication reading process.

At S2, the main CPU41 sequentially reads and executes from the RAM43 the game program or the like authenticated in the authentication reading process (S1), and performs main game processing. By executing this main game processing, a game is performed at the slot machine 1 according to the embodiment. Then, the main game processing is repeatedly executed while power is supplied to the slot machine 1.

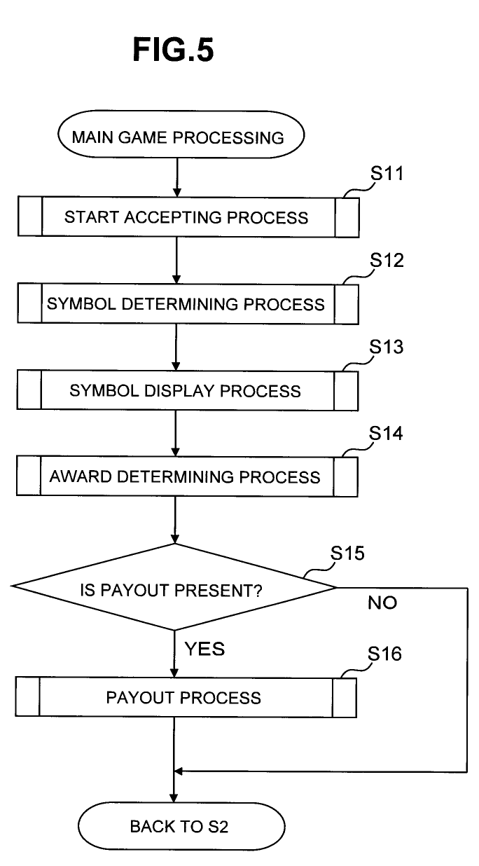

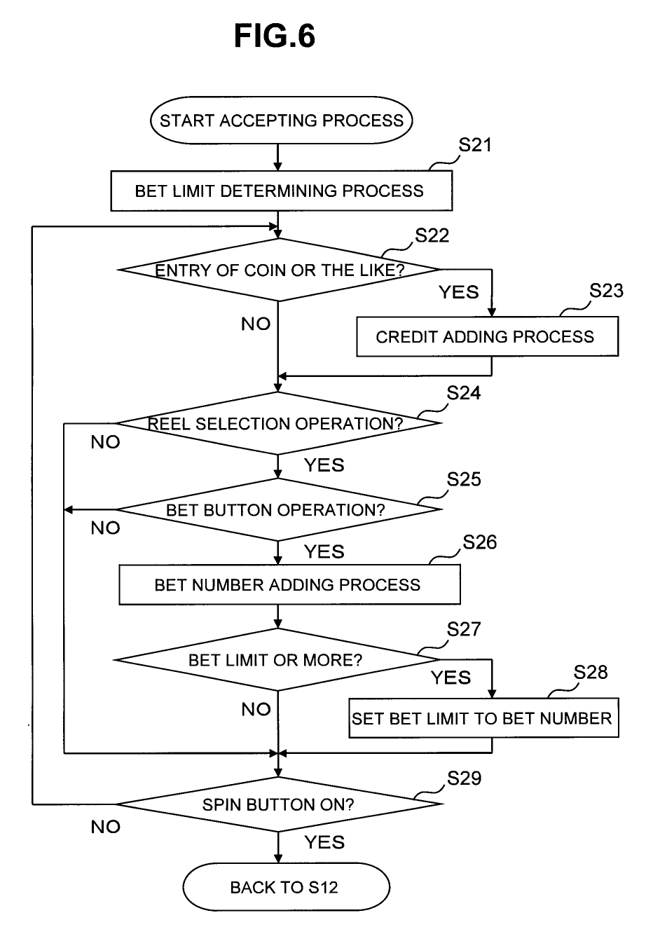

Next, a main game processing program of the slot machine 1 according to the embodiment will be described in detail with referring to the drawings. FIG. 5 is a flow chart of the main game processing program according to the slot machine 1. The programs shown by way of a flow chart in FIG. 6 and FIGS. 8 to 10 are stored in the memory card 53. These programs are decompressed in the RAM43 in the authentication reading processing (S1), and are executed by the main CPU41.

As shown in FIG. 5, first, the main CPU41 performs a start accepting process (S11) after performing a predetermined initializing process. At this time, in the initializing process, processing such as clearing data (such as a number-of-coin-out counter, for example) on items set in a predetermined data area is performed. In the start accepting process (S11), the main CPU41 performs a process of setting the number of bets on a one-by-one reel display area basis (the first to third reel display areas 10 to 12), based upon operation of the 1-BET button 16, the MAX-BET button 17, and the touch panel 25 by a player. In this start accepting process (S11), a “bet limit” is associated with each of the reel display areas (the first to third reel display areas 10 to 12). After the start accepting process (S11) terminates, the main CPU41 proceeds to a symbol display process (S13). This symbol determining process (S11) will be described in detail later.

When the routine proceeds to step S12, the main CPU41 executes a symbol determining process. Specifically, in the symbol determining process (S12), the main CPU41 specifies a reel display area (hereinafter, referred to as a “target reel display area”) in which a gaming value is betted in the start accepting process (S11), and determines a symbol displayed in a stopped state in the target reel display area, based upon a video reel and a lottery program according to the target reel display area. In this symbol determining process, a symbol displayed in a stopped state in a reel display area other than the target reel display area (hereinafter, referred to as a non-target reel display area) is not determined. After determining the symbol displayed in a stopped state in the target reel display area, the main CPU41 proceeds to a symbol display process (S13). The symbol determining process (S12) will be described in detail later with referring to the drawings.

When the routine proceeds to the symbol display process (S13), the main CPU41 variably displays a symbol in accordance with a video reel in the target reel display area. When a predetermined period has elapsed after starting variable display of a symbol, the main CPU stops and displays in the target reel display area the symbol determined by the symbol determining process (S12). At this time, in the non-target reel display area, a symbol is not variably displayed, and a symbol is maintained to be displayed in a stopped state. After the symbol is variably displayed and is displayed in a stopped state in the target reel display area, the main CPU41 terminates the symbol display process (S13), and proceeds to step S14. The symbol display process (S13) will be described in detail later with referring to the drawings.

At S14, the main CPU41 executes an award determining process. In this award determining process (S14), the main CPU41 determines the content of an award to be given to a player, based upon the symbol displayed in a stopped state in the target reel display area. Specifically, the main CPU41 determines the contents of the first and second prizes, and determines these contents as awards to be given to a player. The content of the first prize is determined based upon symbols displayed in a stopped state in the target reel display area and the number of bets betted in the target reel display area. For the content of the second prize, all of the first to third reel display areas 10 to 12 are the target reel display areas, and the contents of award are determined when a combination of symbols displayed in a stopped state in three target reel display areas corresponds to a predetermined winning combination. After performing award determination according to the contents of the first and second prizes, and then, determining the award given to a player, the main CPU41 proceeds to S15. The award determining process (S14) will be described in detail later with referring to the drawings.

When the routine proceeds to step S15, the main CPU41 determines whether or not a payout (i.e., an award given to a player) exists based upon a determination result of the award determining process (S14). When the payout exists (S15: YES), the main CPU proceeds to a payout process (S16). Then, in the payout process (S16), the main CPU41 pays out to a player a payout that is based upon the determination result of the award determining process (S14). At this time, the payout may be added to credits, and can be paid out by coins, the number of which corresponds to the payout. When paying out of the payout completes, the main CPU41 terminates a main game processing program. On the other hand, when the payout based upon the determination result of the award determining process (S14) is “0” (S15: NO), the main CPU41 terminates the main game processing program as it is. Then, when the main game processing program terminates, the main CPU41 executes the main game processing (S2) again, based upon a main control program (see FIG. 4). That is, after the main game processing program terminates, the slot machine 1 executes the main game processing program again to start a new game.

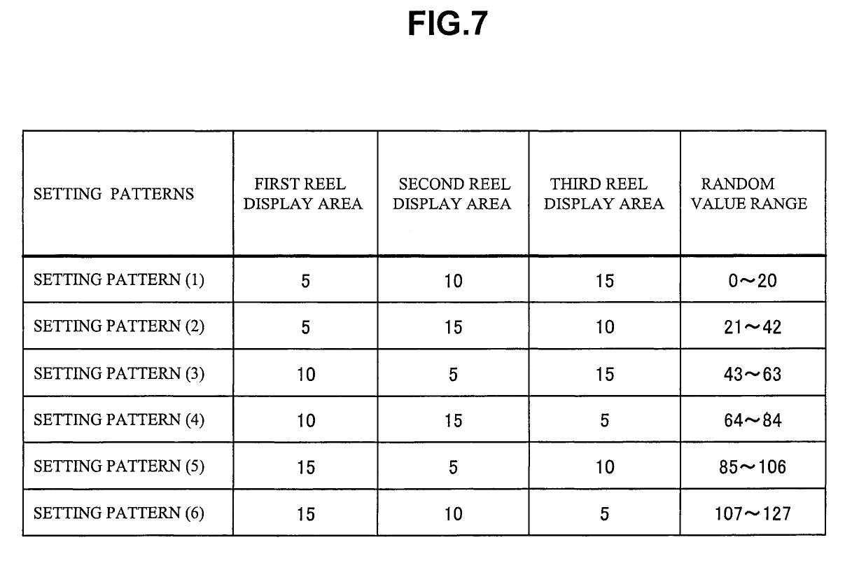

Hereinafter, the start accepting program executed in S11 for main game processing will be described in detail with referring to the drawings. FIG. 6 is a flow chart of the start accepting program. When the routine proceeds to the start accepting process (S11), the main CPU41 executes a bet limit determining process (S21). In the bet limit determining process (S21), the main CPU41 determines a bet limit relative to each of the first to third reel display areas 10 to 12. Specifically, the slot machine 1 stores a setting pattern table (see FIG. 7) in which plural types of setting patterns of bet limits relative to reel display areas were specified. The main CPU41 determines the bet limit of each reel display area according to a current game, based upon the setting pattern table and a lottery result of a lottery program. After determining the bet limit of each reel display area according to the current game, the main CPU41 proceeds to step S22.

Now, the setting pattern table will be described in detail with referring to the drawings. FIG. 7 is an illustrative view of the setting pattern table. As shown in FIG. 7, in the embodiment, six setting patterns, i.e., “setting patterns (1) to (6)” are specified as those of the bet limits relative to the first to third reel display areas 10 to 12. In the setting patterns, “bet limit: 5”, “bet limit: 10”, and “bet limit: 15” are associated with any of the first to third reel display areas 10 to 12, respectively. A predetermined random number range is associated with each of the setting patterns. Therefore, the main CPU41 executes a lottery program, and samples a given random number value, whereby one setting pattern can be determined.

Now, a bet limit determining process (S21) will be specifically described. For example, assume that the main CPU41 executes a lottery program, thereby sampling a random number value belonging to a random number range of “43 to 63”. In this case, as shown in FIG. 7, the setting pattern in the current game is determined to be “setting pattern (3)”. Therefore, the bet limit relative to each of the reel display areas in the current game is set based upon “setting patter (3)”. That is, the bet limit of the first reel display area 10 is set at “bet limit: 10”, and the bet limit of the second reel display area 11 is set at “bet limit: 5”. Then, the bet limit of the third reel display area 12 is set at “bet limit: 15”. After the thus determined bet limit of such each reel display area according to the current game has been stored in a RAM43, the main CPU proceeds to step S22.

When the routine proceeds to step S22, the main CPU41 determines whether or not a coin or the like (i.e., a coin or a bill) has been entered. Specifically, the main CPU41 makes determination of S22 based upon a signal from a coin counter 21C. When a coin or the like has been entered (S22: YES), the main CPU41 executes a credit adding process (S23). In the credit adding process (S23), the main CPU41 adds a credit responsive to the entered coin to a current credit. After adding the credit corresponding to the entered coin, the main CPU proceeds to step S24. On the other hand, if the coin has not been entered (S22: NO), the main CPU41 proceeds to step S24.

When the routine proceeds to step S24, the main CPU41 determines whether or not a reel selection operation has been performed. The reel selection operation is an operation of selecting a reel display area for betting a gaming value from the first to third reel display areas 10 to 12. Specifically, in the embodiment, the reel selection operation is performed by pressing a touch panel 25 corresponding to a bet number display part 1. As described above, the bet number display part 18 is formed immediately beneath each of the first to third reel display areas 10 to 12 (see FIG. 1). The bet number display parts are associated with the reel display areas, respectively. The touch panel 25 transmits an operation signal to the main CPU41 based upon a pressing operation at a predetermined portion (that is, the bet number display part 18). Therefore, when a player presses the bet number display part 18 corresponding to a desired reel display area, the main CPU41 can specify the reel display area selected by the player and can accept selection of the target reel display area. When a reel selection operation is performed (S24: YES), the main CPU41 specifies the selected reel display area, based upon an operation signal from the touch panel 25, and stores data indicative of the reel display area in a RAM43. Then, the main CPU41 proceed to step S25. If the reel selection operation is not performed (S24: NO), the main CPU41 proceeds to step S29.

At S25 at which the routine proceeds to a case where the reel selection operation is performed (S24: YES), the main CPU41 determines whether or not operations of a 1-BET button 16 and a MAX-BET BUTTON 17 have been performed. Specifically, the main CPU41 makes determination at S25, based upon a signal transmitted from the 1-BET switch 16S and the MAX-BET switch 17S. When operation of the 1-BET button 16 or the like has been performed (S25: YES), the main CPU41 proceeds to a bet number adding process (S26). When operation of the 1-BET button 16 or the like has not been performed (S25: NO), the main CPU proceeds to S29.

In the bet number adding process (S26), the main CPU41 handles, as a bet number, a gaming value corresponding to operation of the 1-BET button 16 and the MAX-BET button 17, and adds the handled bet number to a bet number relative to a reel display area selected at S24. That is, when the 1-BET button 16 has been operated, the main CPU41 adds “1” to the current bet number according to the selected reel display area. When the MAX-BET button 17 has been operated, the main CPU41 adds a bet number so that the bet limit set in the selected reel display area becomes a bet number. That is, the main CPU41 calculates a difference between the bet limit and the current bet number, which were set for the selected reel display area, and adds the bet number corresponding to the difference to that in the reel display area. After storing in the RAM43 the bet number after added, according to the reel display area, the main CPU41 proceeds to step S27.

When the routine proceeds to step S27, the main CPU41 determines whether or not the bet number added in the bet number adding process (S26) is equal to or greater than the bet limit set in the reel display area. Specifically, the main CPU41 makes determination at S27 by reading the bet limit and current bet number according to the reel display area from the RAM43, and then, comparing the readings with each other. When the bet number according to the selected reel display area is equal to or greater than the set bet limit (S27: YES), the main CPU41 proceeds to step S28. On the other hand, when the bet number according to the reel display area is more than the bet limit (S27: NO), the main CPU41 proceeds to step S29.

When the routine proceeds to step S28, the main CPU41 sets the bet limit as a bet number. If the bet number exceeding the bet limit according to the reel display area is set by operation of the 1-BET button 16 or the like, the gaming value corresponding to an excess of the bet limit is returned to a credit as redundancy. After the bet limit according to the selected reel display area is set as a bet number according to the reel display area, the main CPU41 proceeds to step S29.

When the routine proceeds to step S29, the main CPU41 determines whether or not operation of the SPIN button 13 has been performed. Specifically, the main CPU41 makes determination at S29 based upon whether or not an operation signal has been received from the SPIN switch 13S. When the SPIN button 13 has been operated (S29: YES), the main CPU41 determines the bet number relative to each of the reel display areas, and terminates a start accepting program. That is, the main CPU41 determines the bet number relative to each of the first to third reel display areas 10 to 12 in a current game, based upon operation of the SPIN button 13. When the start accepting program is terminated, the main CPU41 proceeds to a symbol determining process (S12) of a main game processing program. If the SPIN button 13 has not been operated (S29: NO), the main CPU41 returns to step S22. A player can thereby add or modify a bet of a gaming value relative to each of the reel display areas.

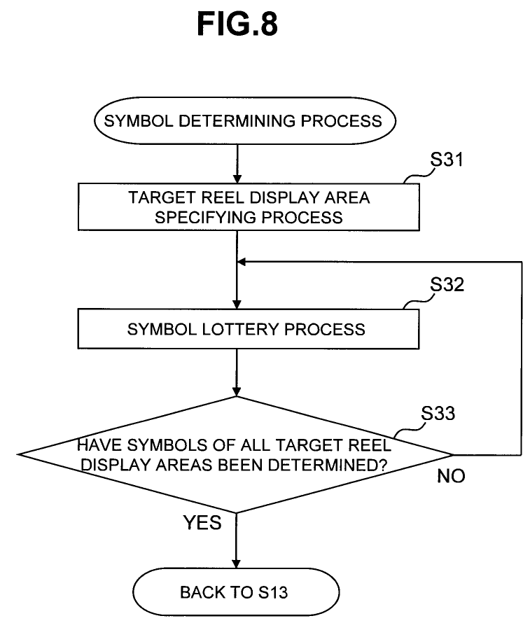

Next, a symbol determination processing program executed at S12 of a main game processing program will be described in detail later with referring to the drawings. FIG. 8 is a flow chart of the symbol determination processing program. After the start accepting process (S11) has terminated, when the step moves to the symbol determining process (S12), the main CPU41 starts execution of the symbol determination processing program. As shown in FIG. 8, when execution of the symbol determination processing program is started, the main CPU41 executes a target reel display area specifying process (S31). This target reel display area specifying process (S31) is a process of specifying a reel display area in which a gaming value has been betted. Specifically, the main CPU41 specifies the target reel display area by referring to the number of bets relative to each of the stored reel display area of the RAM43. After specifying the target reel display area, the main CPU41 proceeds to step S32.

When the routine proceeds to step S32, the main CPU41 executes a symbol lottery process. In this symbol lottery process (S32), a symbol to be displayed in a stopped state in a target reel display area is determined by lottery. As described above, symbols constituting a video reel according to the embodiment are specified code Nos., respectively. A predetermined random number value is assigned to each of code Nos. Therefore, the main CPU41 can determine a symbol to be displayed in a stopped state in a reel display area, via code No. by executing a lottery program and sampling a random number value. Namely, in this symbol lottery process (S32), the main CPU41 samples the random number value by executing the lottery program. The main CPU41 determines, in a target reel display area, a symbol to be displayed in a stopped state, via code No. according to a video reel corresponding to the random number value and target reel display area. After determining the symbol to be displayed in a stopped state in one target reel display area, the main CPU41 stores a lottery result in the RAM43, and proceeds to step S33.

At S33, the main CPU41 determines whether or not symbols to be displayed in a stopped state have been determined for all of the target reel display areas. The main CPU41 makes determination at S33 by referring to stored target reel display areas of the RAM43 and a lottery result relative to the target reel display area. When symbols to be displayed in a stopped state has been determined for all of the target reel display areas (S33: YES), the main CPU41 terminates a symbol determining program, and proceeds to a symbol display process of a main game processing program (S13). If there exists a target reel display area in which a symbol to be displayed in a stopped state has not been determined yet (S33: NO), the main CPU41 returns to step S32. Therefore, the main CPU41 repeats the symbol lottery process (S32) until symbols to be displayed in a stopped state are determined for all of the target reel display areas determined in the start accepting process (S11).

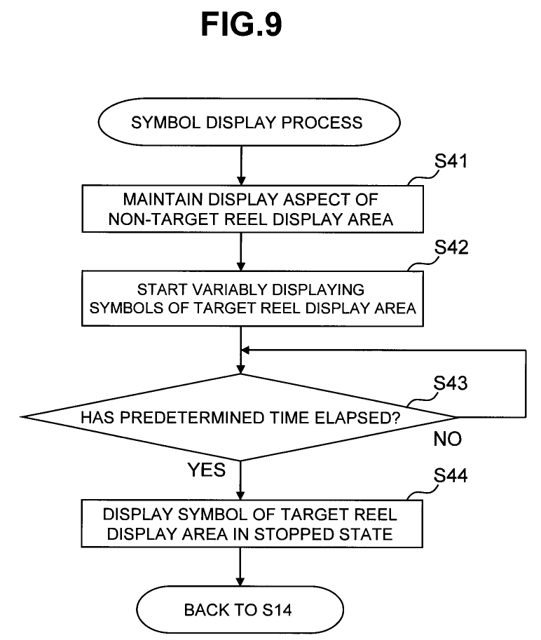

Next, the symbol display processing program executed at S13 of the main game processing program will be described in detail with referring to the drawing. FIG. 9 is a flow chart of the symbol display processing program. When the routine proceeds to the symbol display process (S13), the main CPU41 continues displaying of symbols that are currently displayed in a stopped state, and maintains a display aspect at a current time point, in a non-target reel display area (S41). That is, the main CPU41 continuously executes current control for the non-target reel display area in which a gaming value has not been betted.

At S42 that follows, the main CPU41 transmits a variable display signal to a graphic board 68 to start variably displaying a symbol in the target reel display area. The target reel display area is specified for this variable display signal. Symbols are thereby started to be variably displayed in the target reel display areas. Symbols are variably displayed in the target reel display area, based upon a video reel according to the target reel display area. Symbols are variably displayed simultaneously in all of the target reel display areas. In this regard, the main CPU41 does not transmit to the graphic board 68 a variable display area pertinent to the non-target reel display area described above. In the slot machine 1, therefore, symbols are not variably displayed in the non-target reel display area, and symbols, which were displayed in a stopped state in the previous game, are displayed in a stopped state as they are (see FIG. 1). After the variable display signal has been transmitted to start variably displaying symbols in the target reel display area, the main CPU41 proceeds to step S43.

When the routine proceeds to step S43, the main CPU41 determines whether or not a predetermined time has elapsed at and after a time point when variable display of symbols have been started. When the predetermined time has elapsed (S43: YES), the main CPU41 proceeds to step S44. If the predetermined time has not elapsed yet (S43: NO), the main CPU41 returns to step S43, and waits until the predetermined time has elapsed.

When the predetermined time has elapsed (S43: YES), the main CPU41 transmits a stop display signal to the graphic board 68 to stop variable display of symbols in the target reel display areas (S44). That is, the main CPU41 acquires a lottery result of the target reel display area with referring to the RAM43. Then, the main CPU41 generates a stop display signal indicative of the lottery result according to the target reel display area, and transmits the stop display signal to the graphic board 68. In the slot machine 1, the symbols determined in the symbol determination process (S12) are thereby displayed in a stopped state in the target reel display areas. When the symbols determined in the symbol determining process (S12) are displayed in a stopped state in the target reel display areas, the main CPU41 terminates a symbol display processing program, and proceeds to step S14 of the main game processing program.

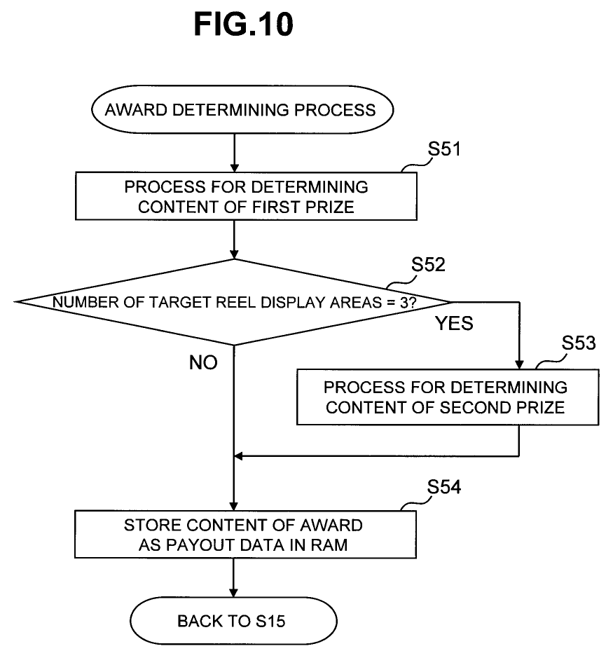

Next, an award determination processing program executed at S14 of the main game processing program will be described in detail with referring to the drawings. FIG. 10 is a flow chart of the award determination processing program. When the routine proceeds to the award determining process (S14), the main CPU41 executes the award determination processing program, and executes a process of determining the content of the first prize (S51). The process of determining the content of the first prize is a process of determining the content of the first prize based upon the bet number relative to the target reel display area. If a plurality of target reel display areas exist, the main CPU41 performs award determination according to the content of the first prize on a one-by-one reel display area basis, and determines, as the content of the first prize, a total value of determination results relative to the target reel display areas. After determining the content of the first prize according to a current game and storing the determined content in the RAM43, the main CPU41 proceeds to step S52.

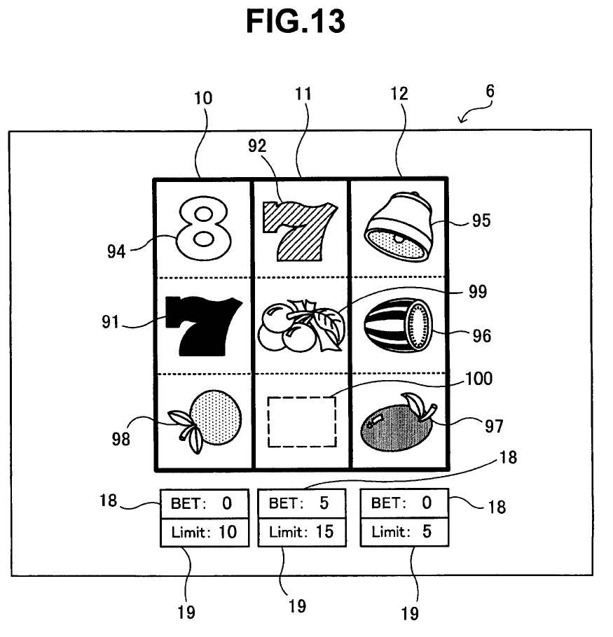

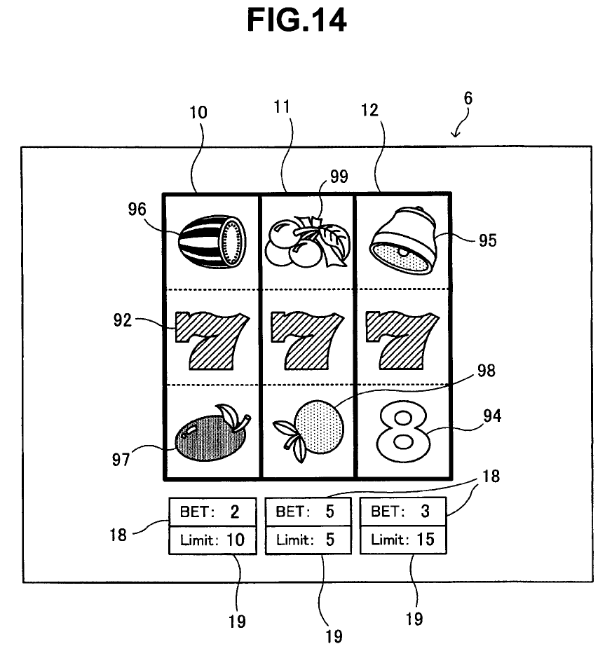

Now, a process of determining the content of the first prize (S51) will be specifically described by way of examples shown in FIG. 13 and FIG. 14. First, the process of determining the content of the first prize (S51) in the case of the specific example shown in FIG. 13 will be described. In the case of the example shown in FIG. 13, as is evident from the bet number shown in the bet number display part 18, only the second reel display area 11 is a “target reel display area”. In the case of FIG. 13, three symbols “RED SEVEN 92”, “CHERRY 99”, and “BLANK 100” are displayed in a stopped state in the second reel display area 11. The bet number according to the second reel display area is “5”, as displayed at the bet number display 18. In a table of determining the content of the first prize shown in FIG. 11, payout rates “X20”, “X1”, and “X0” are associated with “RED SEVEN 92”, “CHERRY 99”, and “BLANK 100”, respectively. Therefore, the content of the first prize in the target reel display area (namely, the second reel display area 11) is calculated by a sum of payouts, each of which obtained by multiplying a payout rate specified for each symbol, for “5” that is the number of bets. That is, in the case of FIG. 13, the content of the first prize is calculated by “5×20”+“5×1”+“5×0”, and corresponds to the payout of “125”.

Next, a process of determining the content of the first prize (S51) in the case of the example shown in FIG. 14 will be described. In this case, as is seen from the bet number display part 18 relative to the reel display areas, all of the first to third reel display areas 10 to 12 correspond to the target reel display areas. In the first reel display area 10, symbols “WATER MELON 96”, “RED SEVEN 92”, and “PLUM 97” are displayed in a stopped state, and the number of bets is “2”. Therefore, the payout according to the first reel display area 10 is calculated to be 50 based upon “2×3”+“2×20”+“2×2”. Then, the payouts according to the second and third reel display areas 11 and 12 are also calculated in the same manner as that in the first reel display area 10. That is, the payout according to the second reel display area 11 is calculated to be “115”, and the payout according to the third reel display area 12 is calculated to be “84”. That is, in the case of the example shown in FIG. 14, the payout of “249, which is a sum of “50”, “115”, and “84”, is determined to be the content of the first prize.

When the content of the first prize determined in the process of determining the content of the first prize (S51) is stored in the RAM43, the main CPU41 determines whether or not the number of target reel display areas is “3” at S52. That is, at S52, the main CPU41 determines whether or not gaming values are betted on all of the reel display areas and all of them become the target reel display areas. The main CPU41 makes determination at S52 by referring to the number of bets in each of the reel display areas stored in the RAM43. When the number of target reel display areas is “3” (S52: YES), the main CPU41 proceeds to the process of determining the content of the second prize (S53). If the number of target reel display areas is “1” or “2” (S52: NO), the main CPU41 proceeds to S54.

When the routine proceeds to step S53, the main CPU41 executes the process of determining the content of the second prize. In the process of determining the content of the second prize (S53), the main CPU41 determines the content of the second prize, based upon a combination of symbols displayed in a stopped state in the target reel display areas and the table for determining the content of the second prize (see FIG. 12). The content of the second prize does not vary responsive to the number of bets. As shown in FIG. 12, a plurality of predetermined winning combinations are specified in the table of determining the content of the second prize. Payouts are specified for winning combinations, respectively. In the process of determining the content of the second prize (S53), therefore, the main CPU41 determines whether or not a winning combination specified in the table of determining the content of the second prize is included in nine symbols displayed in a stopped state in the first to third reel display areas 10 to 12. If the winning combination is included, the main CPU41 determines the payout corresponding to the winning combination as the content of the second prize with referring to the table of determining the content of the second prize. After the payout determined to be the content of the second prize has been stored in the RAM43, the main CPU41 proceeds to step S54.

Now, the process of determining the content of the second prize (S53) will be specifically described by way of example shown in FIG. 14. In the case of a specific example shown in FIG. 13, only the second reel display area 11 is a target reel display area (S52: NO), and thus, the process of determining the content of the second prize (S53) is not executed.

In the case of an example shown in FIG. 14, as is seen from the bet number display part 18 relative to the reel display areas, all of the first to third reel display areas 10 to 12 correspond to the target reel display areas (S52: YES). In the case of the example shown in FIG. 14, therefore, the process of determining the content of the second prize (S53) is executed in the slot machine 1. As shown in FIG. 14, in each of the first to third reel display areas 10 to 12, “RED SEVEN 92” is displayed in a stopped state at a middle stage of each of the reel display areas. Namely, in the lottery result in the case of the example shown in FIG. 14, a winning combination of symbols “RED SEVEN 92” (i.e., RED 7-RED 7-RED7) is included. Therefore, the main CPU41 determines a payout “100” according to the winning combination of the “RED SEVEN 92” as the content of the second prize, and stores the payout in the RAM43.

In this regard, in the embodiment, in addition to the case of the example shown in FIG. 14, the content of the second prize is provided when a winning combination is included in symbols displayed in a stopped state, respectively, at the upper stages of the first to third reel display areas 10 to 12 and those displayed in a stopped state at the lower stages of the reel display areas as well. In addition, the main CPU41 gives the content of the second prize when a winning combination is constituted of symbols displayed in a stopped state at the upper stage of the first reel display area 10, at the middle stage of the second reel display area 11, and at the lower stage of the third reel display area 12. The content of the second prize is also given when a winning combination is constituted of symbols displayed in a stopped state at the lower stage of the first reel display area 10, at the middle stage of the second reel display area 11, and at the upper stage of the third reel display area 12 as well.

In the process of determining the content of the second prize (S53), any determination aspect is available as long as nine symbols displayed in a stopped state in the first to third reel display areas 10 to 12 are targeted to be determined. That is, the content of the second prize can also be constituted so as to be determined depending upon the number of symbols of the same type included in nine symbols displayed in a stopped state in the first to third reel display areas 10 to 12. In this case, a table in which a payout is specified according to types of number of symbols is used as a table of determining the content of the second prize.

When the routine proceeds to step S54, the main CPU41 stores in the RAM43 the contents of the first and second prizes as payouts given to a player. For example, as is the case with the example shown in FIG. 13, if the only the content of the first prize is given (S52: NO), the main CPU41 stores (S54), as payout data in the RAM43, the payout according to the content of the first prize that was determined in the process of determining the content of the first prize (S51). In the case of FIG. 13, the main CPU41 stores, in the RAM43, payout data “5” that is the content of the first prize. As in FIG. 14, if the contents of the first and second prizes are given as payouts (S52: YES), the main CPU41 combines the contents of the first and second prizes stored in the RAM43 with each other, and stores the combined contents as payout data in the RAM43. That is, in the case of FIG. 14, the main CPU41 stores in the RAM43, payout data “349” obtained by adding up “249” according to the content of the first prize and “100” according to the content of the second prize. After the payout data based upon the contents of the first and second prizes is stored in the RAM43, the main CPU41 terminates an award determination processing program, and proceeds to step S15 of the main game processing program.

As described above, with the slot machine 1 according to the embodiment, in the start accepting process (S11), a gaming value can be arbitrarily betted on each of the first to third reel display areas 10 to 12. Namely, the number of bets relative to each of the reel display areas can be set differently, so that the bet aspects of gaming values can be diversified in the slot machine 1, whereby new entertainment can be provided to a player. Only processing operations according to target reel display areas in which gaming values have been betted are performed in the symbol determining process (S12) and the symbol display process (S13). That is, the processing operations according to the determination and displaying of symbols relative to a non-target reel display area are not performed. In this manner, the slot machine 1 can reduce a processing burden on a game controller.

The slot machine 1 according to the embodiment is constituted so as to give a player the payouts that are based upon the contents of the first and second prizes. When only one or two reel display areas are target reel display areas, the main CPU41 gives a player only the content of the first prize. When all of the reel display areas are target reel display areas, the main CPU41 gives the player the contents of the first and second prizes. That is, in the clot machine 1, a possibility of earning a large profit varies according to a bet aspect. As a result, the slot machine 1 can enhance the “entertainment based upon the fact that betting is possible on a one-by-one reel display area basis” of the player.

In the slot machine 1 according to the embodiment, a bet limit is set in each of the first to third reel display areas 10 to 12. This bet limit is set so as to be different from that according to another reel display area (see FIG. 7). In the start accepting process (S11), when a gaming value is betted in each reel display area, if a gaming value equal to or greater than the bet limit is betted, the main CPU41 sets the bet limit as a bet number, and stores a redundancy as a credit. Namely, in the slot machine 1, even if a gaming value is betted at all of the reel display areas to the bet limit, the bet number relative to each reel display area is different. As a result, conditions according to determination of the content of the first prize in reel display areas are different from each other, so that the slot machine 1 can offer to a player an entertainment that is based upon the fact that betting is arbitrarily possible on a one-by-one display part basis.

The present invention is not limited to the embodiment, and various modifications and alterations can occur without departing from the spirit of the present invention, of course. For example, while, in the embodiment, the slot machine 1 was a so-called video slot machine, the present invention is applicable to a mechanical slot machine.

While, in the embodiment, the slot machine 1 was constituted so as to include three reel display areas of the first to third reel display areas 10 to 12, the number of reel display areas is not limited to 3. For example, the number of reels may be 5. While, in the embodiment, the process of determining the content of the second prize (S53) was executed when all of the reel display areas were the target reel display areas, it is possible to constitute the process of determining the content of the second prize (S53) so as to be executed if two or more reel display areas are the target reel display areas. In this case, it is desirable that the table of determining the content of the second prize be a table in which a payout is specified based upon types of symbols and the number of symbols of the types.

Further, while, in the embodiment, three symbols are constituted so as to be displayed in a stopped state with respect to the first to third reel display areas 10 to 12, respectively, the present invention is not limitative thereto. That is, it is also possible to constitute one symbol to be displayed in a stopped state in each of the reel display areas.

What is claimed is:

1. A slot machine, comprising:
a display device having a plurality of reel display parts at which plural types of symbols are variably displayed and are displayed in a stopped state; and
a game controller configured to:
a) arbitrarily accept a bet of a gaming value on a one-by-one reel display part basis with respect to each of plural reel display parts formed on the display device;
b) determine a symbol displayed in a stopped state at a reel display part at which the gaming value is betted;
c) variably display the symbol at the reel display part at which the gaming value is betted, and then, display the determined symbol in a stopped state at the reel display part; and
d) determine the content of a prize, based upon the symbol displayed in a stopped state at the betted reel display part, and then, give an award that is based upon the determined content of the prize.

2. The slot machine of claim 1, wherein the game controller is configured to set a maximum limit of a gaming value that can be betted with respect to the reel display part and to accept a bet of a gaming value relative to the reel display part to the set maximum limit, and
the maximum limit according to one reel display part is different from the maximum limit according to another reel display part.

3. A slot machine, comprising:
a display device having a plurality of reel display parts at which plural types of symbols are variably displayed and are displayed in a stopped state; and
a game controller configured to:
a) arbitrarily accept a bet of a game value on a one-by-one reel display part basis with respect to each of plural reel display parts formed on the display device;
b) determine a symbol displayed in a stopped state at a reel display part at which the gaming value is betted;
c) variably display the symbol at the reel display part at which the gaming value is betted while maintaining a stopped state of a symbol at a reel display part at which the gaming value is not betted, and then, display the determined symbol in a stopped state at the reel display part at which the gaming value is betted; and
d) determine the content of a prize based upon the symbol displayed in a stopped state at the bet reel display part, and then, give an award that is based upon the determined content of the prize.

4. The slot machine of claim 3, wherein the game controller is configured to set a maximum limit of a gaming value that can be betted with respect to the reel display part and to accept a bet of a gaming value relative to the reel display part to the set maximum limit, and
the maximum limit according to one reel display part is different from the maximum limit according to another reel display part.

5. A slot machine, comprising:
a display device having a plurality of reel display parts at which plural types of symbols are variably displayed and are displayed in a stopped state; and
a game controller configured to:
a) arbitrarily accept a bet of a gaming value on a one-by-one reel display part basis with respect to a plurality of reel display parts formed on the display;
b) determine a symbol displayed in a stopped state at a reel display part at which the gaming value is betted;
c) variably display the symbol at the reel display part at which the gaming value is betted and maintain a stopped state of a symbol at a reel display part at which the gaming value is not bet, and then, display the determined symbol in a stopped state at the reel display part at which the gaming value is betted; and
d) determine the content of a first prize that is based upon a symbol displayed in a stopped state at the bet reel display part, based upon the content of the prize specified for the symbol, and determine the content of a second prize that is based upon a combination of symbols consisting of symbols displayed in a stopped state at a plurality of bet reel display parts, and then, give awards based upon the contents of the first and second prizes.

6. The slot machine of claim 5, wherein the game controller is configured to set a maximum limit of a gaming value that can be betted with respect to the reel display part and accept a bet of a gaming value relative to the reel display part to the set maximum limit, and a maximum limit according to one reel display part is different from a maximum limit according to another reel display part.
